(19) United States
(12) Patent Application Publication
(10) Pub. No.: US 2002/0008886 A1
(43) Pub. Date: Jan. 24, 2002

(54) Information Medium

(75) Inventors: Gunther Dausmann, Erding (DE); Irina Menz, Diedorf (DE); Gerhard Hochenbleicher, Furstenfeldbruck (DE); Zishao Yang, Erding (DE)

Correspondence Address: Rocco S. Barrese, ESQ., DILWORTH & BARRESE, LLP, 333 Earle Ovington Blvd., Uniondale, NY, 11553, US

(73) Assignee: HSM Holographic Systems Munchen GmbH

(21) Appl. No.: 09/908,239

(22) Filed: Jul. 18, 2001

(30) Foreign Application Priority Data
Jul. 18, 2000 (DE) 100 34 856.4

(51) Int. Cl. G03H 1/02

(52) U.S. Cl. 359/3; 359/9; 359/32; 235/457

(57) ABSTRACT

An information medium consists of an essentially circular or polygonal disk having at least two pairs of sides parallel to one another which have the same distance to one another in each pair. To reliably read stored data from such an information medium at high speed, a hologram is disposed on at least one side of the disk at its center or at the intersection of two crossing symmetry lines which can be reconstructed with a reference beam incident to the side at a right angle to a pattern consisting of essentially concentric circles, with the reference beam forming the axis of said pattern.

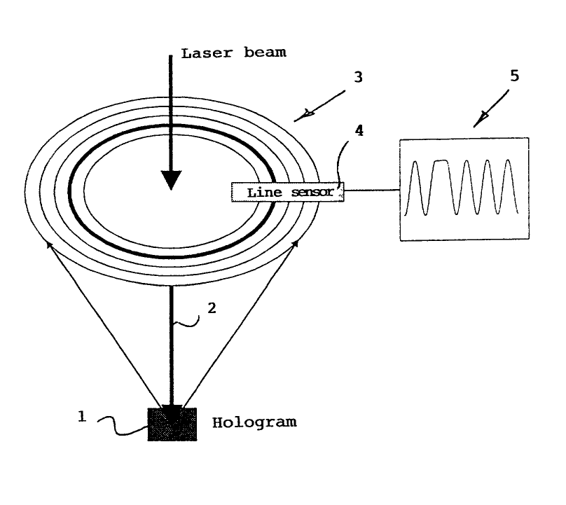

The invention relates to an information medium in the form of an essentially circular or polygonal disk having at least two pairs of sides parallel to one another which have the same distance to one another in each pair.

Such disk-like information media are known in various forms. They can be made, for example, as coins, tokens, jetons or chips which embody a certain value. There is a need with such disk-like information media or tokens embodying a value to be able to automatically read the information stored in them, for example the value embodied in them.

It is therefore the object of the invention to provide an information medium of the kind first mentioned whose information stored therein can be read reliably at high speed.

This object is solved in accordance with the invention by a hologram being disposed on at least one side of the disk, at its centre or at the intersection of two crossing symmetry lines, which can be reconstructed with a reference beam incident to the side at a right angle to a pattern consisting essentially of concentric circles, with the reference beam forming the axis of the pattern.

The reconstructed pattern can represent a bit pattern, seen for example on a diameter line of the concentric circles, for example in the form of a barcode. If the disk-like information medium passes through a channel matched, for example, to its diameter, the hologram disposed on the at least one side is always located at the centre of the disk so that a reference beam incident to this centre during the passage of the disk reconstructs the pattern which can then be read, for example, by an opto-electronic sensor. This opto-electronic sensor can be an areal camera, but better a line sensor which reads the information stored in the concentric circles on a diameter line which only needs to detect the concentric circles of one ring side.

The diameter of the hologram that is disposed at the centre of a side of the disk-like information medium only needs to be formed in roughly spot like manner and can have an diameter, for example, of 0.5 to 5 mm.

The hologram can be prepared according to the standard known manufacturing methods. Appropriately, it is manufactured in the form of a computer-generated hologram. It can also be a volume hologram. Appropriately, however, it is an embossed hologram which can be manufactured in large numbers at a favourable cost.

An embodiment of the invention is represented in the following by way of the drawing in whose single FIGURE the pattern is illustrated which is reconstructed from a hologram with a perpendicularly incident laser beam and which consists of concentric circles of different thickness.

The hologram 1, which is a hologram of the usual kind, is disposed at the centre of a side of a disk which can be circular or polygonal in a manner such that folding-symmetrical halves are created by opposite corners and by lines drawn through the centre. If the object 3 is reconstructed from a hologram 1 with a laser beam 2 perpendicularly incident on this, circles concentric to the laser beam 2 are created with different distances and/or different thicknesses so that the circles intersected by a diameter line represent information, for example a bit pattern, which can be read by an optical sensor, in the embodiment shown by a line sensor 4. The information read by the line sensor is shown in Diagram 5. This information can be analysed electronically in a known manner.

The hologram 1 can be manufactured most simply with the desired information stored in the reconstructed concentric circles as a computer-generated hologram.

It can, for example, also be manufactured in a manner such that the object, that is the concentric circles containing the information, is stored in a focusing screen which has an aperture at the centre of the concentric circles forming the object. The focusing screen is then exposed to a laser beam in a way such that the reference beam passes through the aperture and part of the laser beam is incident to the focusing screen so that the diffuse rays with the information stored on the focusing screen which are created thereby interfere as object rays with the reference beam on the hologram medium.

Since the hologram 1 is always located on one side of a circular or symmetrical polygonal disk, the information stored in the hologram can be read by a reference beam, for example, the beam of a laser diode, perpendicularly incident to this, with the angular position of the disk being negligible due to the information stored in the concentric circles.

1. An information medium in the form of an essentially circular or polygonal disk having at least two pairs of sides parallel to one another which have the same distance to one another in each pair, characterised in that a hologram is disposed on at least one side of the disk at its centre or at the intersection of two crossing symmetry lines which can be reconstructed to a pattern consisting of essentially concentric circles with a reference beam incident to the side at a right angle, with the reference beam forming the axis of said pattern.

2. An information medium in accordance with claim 1, wherein the pattern is a bit pattern in the form of a bar code.

3. An information medium in accordance with either of claims 1 or 2, wherein the diameter of the hologram is 0.5 to 5 mm.

4. An information medium in accordance with any of claims 1 to 3, wherein the hologram is a computer-generated hologram.

5. An information medium in accordance with any of claims 1 to 4, wherein the hologram is an embossed hologram.
